(19) United States
(12) Patent Application Publication
(10) Pub. No.: US 2004/0072583 A1
(43) Pub. Date: Apr. 15, 2004

(54) Mobile phone device with function of emergency notification

(76) Inventor: Yuan Sung Weng, Taipei (TW)

Correspondence Address: BUCKNAM AND ARCHER, 1077 NORTHERN BOULEVARD, ROSLYN, NY, 11576, US

(21) Appl. No.: 10/639,806

(22) Filed: Aug. 12, 2003

(30) Foreign Application Priority Data
Oct. 9, 2002 (TW) 091216055

(51) Int. Cl. H04M 11/04

(52) U.S. Cl. 455/456.3; 455/404.1

(57) ABSTRACT

The invention relates to a mobile phone device with function of emergency notification, in which a mobile phone is provided to conduct send/receive operation of mobile radio communication, such device is characterized in that the mobile phone is provided with: a global positioning system receiver, for receiving satellite positioning signal and from which a location information is calculated; a memory cell, for temporary storing said location information and permanently storing an emergency notification message and an emergency phone number; and an emergency key, for commanding the mobile phone to send the location information and the emergency notification message to the pre-stored emergency phone number.

### BACKGROUND OF THE INVENTION

1. Field of the Invention

The present invention relates to a mobile phone device with function of emergency notification, especially to a mobile phone device provided with an emergency key that is capable of sending an emergency notification message attached with location information to a pre-stored emergency phone number.

2. Description of the Prior Art

According to the official statistic of U.S. government, there are more than hundred thousands of 911 calls received per month, however, most of the callers are unable to clearly state their locations and result in inefficiency on providing rescue. Federal Communication Committee (FCC) enacted an E-99 regulation in 1996 to require the mobile phone industry to develop a mobile communication system positioning technique so that the emergency rescue center, i.e. PSAP (public safety action party) can detect the location of 911 caller.

There are many ways to solve that regulation requirement, one of which is to provide a built-in GPS receiver so as to send the location information required by the regulation as well as to provide more services for mobile communication.

However, since there are various emergencies such as car accident, fire, kidnapping, or mountain climbing, it is impossible for PSAP to respond with efficient rescue in time simply by the caller's ID and location information; in case of using mobile phone via roaming in different area, country, or service provider, it often failed to send the emergency signal to local PSAP. Therefore, it is necessary for the mobile phone to have a function of sending a pre-stored short message of safety (SMS) to PSAP as well as relatives, friends and colleagues in priority order when placing emergency call, so that PSAP can best respond to such call by incorporating with those people and prevent such call from being missed.

### SUMMARY OF THE INVENTION

Therefore, an object of present invention is to provide a mobile phone device with function of emergency notification, capable of sending an emergency notification message attached with location information to a pre-stored emergency phone number so as to receive rescue in time, except providing send/receive operation of mobile radio communication.

To achieve above object, the present invention provides a mobile phone device with function of emergency notification, in which a mobile phone is provided to conduct send/receive operation of mobile radio communication, such device is characterized in that the mobile phone is provided with: a global positioning system receiver, for receiving satellite positioning signal and from which a location information is calculated; a memory cell, for temporary storing the location information and permanently storing an emergency notification message and an emergency phone number; and an emergency key, for commanding said mobile phone to send the location information and the emergency notification message to the pre-stored emergency phone number.

In one aspect of present invention, the control of the active operation among the global positioning system receiver, memory cell, and emergency key is achieved by means of a processor of the mobile phone or an independent processor.

In another aspect of present invention, the location information of the mobile phone is sent by attaching to the enclosure of the short message of safety.

In still another aspect of present invention, the mobile phone dials the pre-stored emergency phone numbers in priority order and sends its location information as well as the short message of safety to those emergency phone numbers.

### BRIEF DESCRIPTION OF DRAWINGS

The above and other objects, features, and advantages of present invention will become more apparent from the detailed description in conjunction with the following drawings:

FIG. 1 is a block diagram showing the partial structure of a mobile phone device in accordance with present invention.

FIG. 2 is a schematic diagram showing a product of mobile phone device in accordance with present invention.

FIG. 3 is a flow chart showing the procedure of setting a short message of safety.

FIG. 4 is a flow chart showing the operation procedure of a mobile phone device in accordance with present invention.

FIG. 5 is a schematic diagram showing the implementation of an embodiment of present invention.

### DETAILED DESCRIPTION OF THE INVENTION

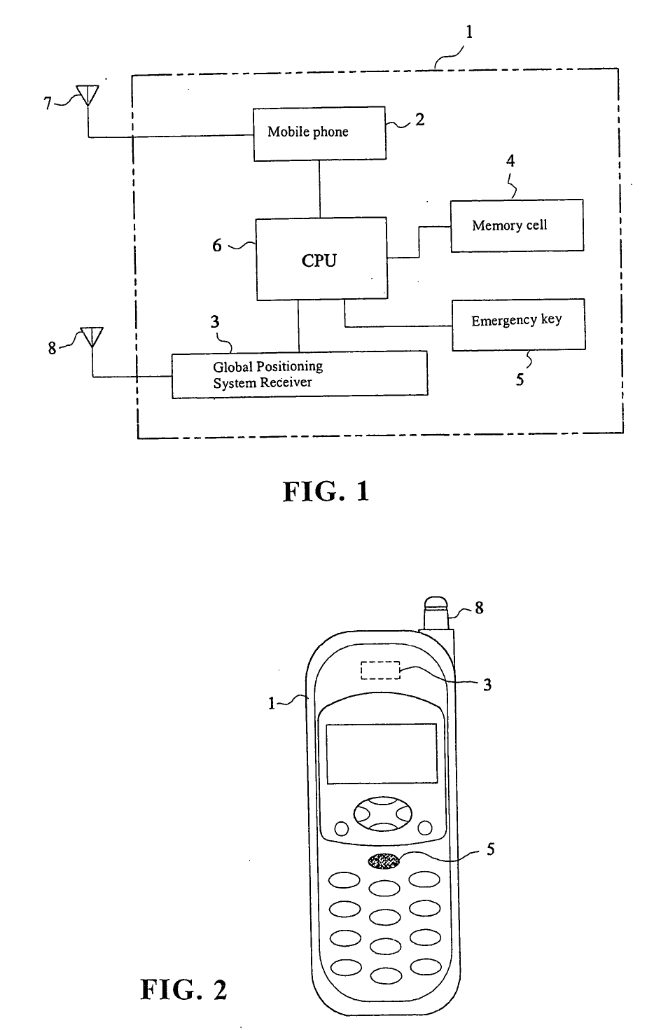

Referred to FIG. 1, FIG. 1 is a block diagram showing the partial structure of a mobile phone device 1 in accordance with present invention. In FIG. 1, a mobile phone used to conduct the send/receive operation of mobile radio communication is shown as a block 2, however in the mobile phone device 1 in accordance with present invention, the mobile phone 2 is provided with a global positioning system (GPS) receiver 3, memory cell 4, and emergency key 5.

The global positioning system (GPS) receiver 3 receives a satellite positioning signal through a GPS antenna 8 according to the command of a central processing unit (CPU) 6, calculates the location information base on received satellite positioning signal, and stores the location information in the memory cell 4. The CPU 6 can be a processor of said mobile phone or an independent processor.

The memory cell 4 stores temporary data such as location information calculated by said mobile phone 2 and pre-stored data such as SMS, where said SMS is stored in the following format:

(1) PSAP phone;

(2) Emergency phone numbers in priority order, for example: the phone numbers of parents and friends;

(3) User's personal information such as ID, name and address;

(4) User's medical information such as blood type, medical history and etc.; and

(5) Other important information or messages.

When being dialed by user in case of emergency, said emergency key 5 will automatically instruct said GPS receiver 3 to receive a satellite positioning signal and calculates a location information through said CPU 6, integrate the location information into the pre-stored SMS, and send the integrated information to emergency phone numbers pre-stored in the memory cell 4 through the antenna 7 of the mobile phone.

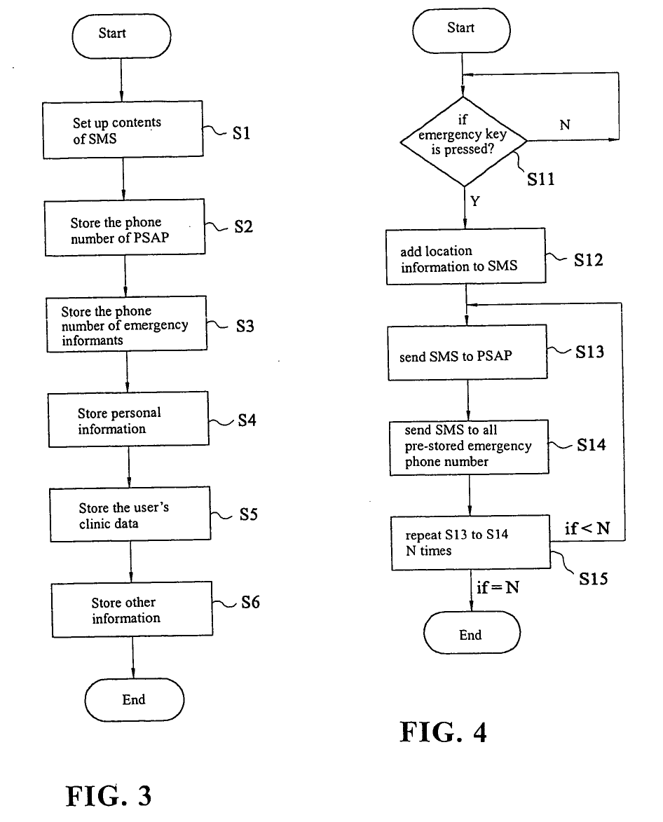

Referred to FIG. 2, FIG. 2 is a schematic diagram showing a product of mobile phone device of present invention, in which the antenna (not shown) of the mobile phone may have hidden design while said GPS receiver 3 is mounted on the top of the mobile phone 2 so as to incorporate with GPS antenna 8 for receiving satellite positioning signal, and the emergency key 5 with specific color is provided on the center of the panel on said mobile phone. The memory cell 4 is buried in the circuit board of the mobile phone, therefore it is not shown in the figure. However, the structure of the mobile phone device 1 is not limited to the arrangement of the preferred embodiment of present invention, for example the combination of the GPS receiver 3, memory cell 4, and emergency key 5 may an independent unit connected to said mobile phone by an interface, so that it is possible to upgrade existing mobile phones to such function. FIG. 3 is a flow chart showing the procedure of setting a short message of safety. First in step S1, setup the contents of SMS. In step S2, store the phone number of PSAP. In step S3, store the phone number of emergency informants such as close relatives or friends in priority order. In step S4, store personal information such as ID number, name and address. In step S5, store the user's clinic data such as blood type, serious disease/trauma, allergy, blood pressure, congenital cardiac disease, and etc. In step S6, store other information such as gender and dietary orientation.

FIG. 4 is a flow chart showing the operation procedure of a mobile phone device in accordance with present invention. First in step S11, the mobile phone 2 will periodically conduct self-check to determine whether the emergency key is pressed? If not, the mobile phone 2 will continue the periodical check; if yes, the process will move to step S12. In step S12, add the location information calculated base on the global positioning signal received by said GPS receiver 3 to the SMS pre-stored in the mobile phone. In step S13, the mobile phone 2 will send the pre-stored SMS to the PSAP through autodial and the process will move to step S14. In step S14, the mobile phone 2 will then send the same SMS to all pre-stored emergency phone numbers in priority order. Finally in step S15, the mobile phone 2 will repeat step S13 to S14 N times.

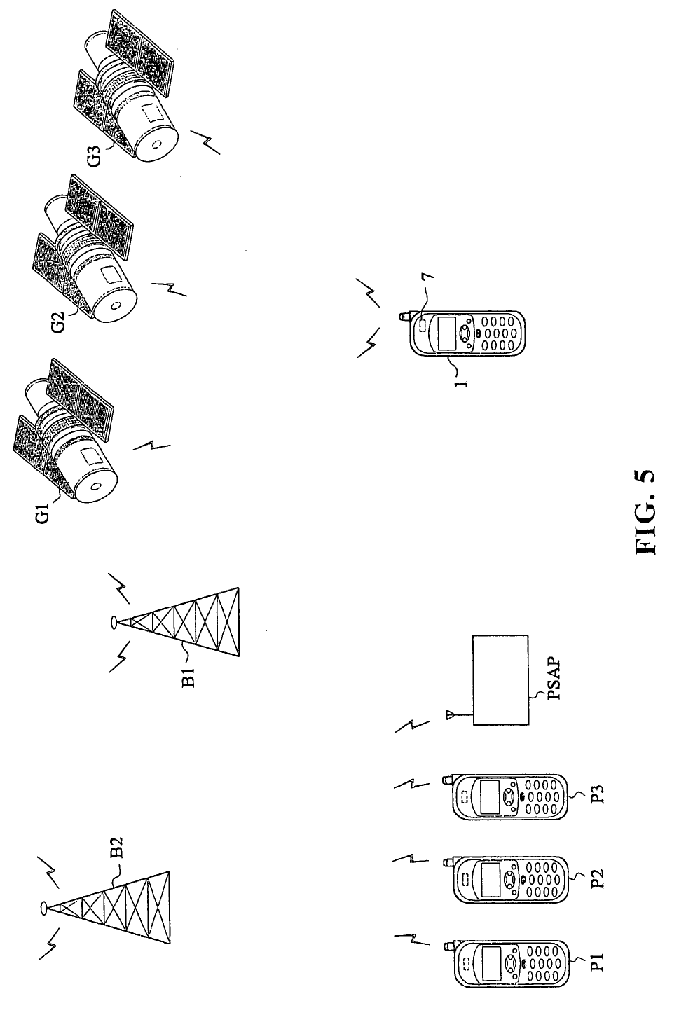

FIG. 5 is a schematic diagram showing the implementation of an embodiment of present invention. As shown in FIG. 5, an emergency rescue contact group constituted of global positioning systems G1, G2, G3, base stations B1, B2, public safety action party PSAP, and emergency informants P1, P2, P3 is formed. However, above described is a preferred embodiment of present invention. Those who skilled in prior technique should understand that present invention is not limited to above description and various modifications and changes in accordance with claims given below are considered to fall within the spirit and scope of present invention.

List of Reference Numerals

| | |
|---|---|
| 1 | mobile phone device with function of emergency notification |
| 2 | mobile phone |
| 3 | global positioning system receiver |
| 4 | memory cell |
| 5 | emergency key |
| 6 | central processing unit (CPU) |
| 7 | communication antenna of mobile phone |
| 8 | global positioning system receiving antenna |

What is claimed is:

1. A mobile phone device with function of emergency notification, in which a mobile phone is provided to conduct send/receive operation of mobile radio communication, said device is characterized in that said mobile phone is provided with: a global positioning system receiver, for receiving satellite positioning signal and from which a location information is calculated; a memory cell, for temporary storing said location information and permanently storing an emergency notification message and an emergency phone number; and an emergency key, for commanding said mobile phone to send the location information and said emergency notification message to said pre-stored emergency phone number.

2. The mobile phone device with function of emergency notification as set forth in claim 1, in which said control of the active operation among said global positioning system receiver, memory cell, and emergency key is achieved by means of a processor of said mobile phone or an independent processor.

3. The mobile phone device with function of emergency notification as set forth in claim 1, in which said location information of said mobile phone is sent by attaching to the enclosure of said short message of safety.

4. The mobile phone device with function of emergency notification as set forth in claim 1 or 3, in which said location information of said mobile phone is sent by attaching to the enclosure of said short message of safety.
